(19) United States
(12) Patent Application Publication
(10) Pub. No.: US 2023/0349151 A1
(43) Pub. Date: Nov. 2, 2023

(54) SOUND ABSORBER AND SOUND ABSORBING DEVICE

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/731,773

(22) Filed: Apr. 28, 2022

(51) Int. Cl. E04B 1/84

(52) U.S. Cl. CPC E04B 1/8404; E04B 2001/848

(57) ABSTRACT

A sound absorber can include a housing including a back wall, a perimeter wall, and an interior wall that form cells having cavities. The sound absorber can also include a panel disposed on the housing that substantially faces the back wall and encloses the cavities of the cells. The panel can define groups of holes for each cell such that one group of holes extend though the panel to the cavity of one cell and another group of holes extend through the panel to the cavity of another cell.

### TECHNICAL FIELD

The subject matter described herein relates, in general, to acoustics and, more specifically, to a sound absorber and a sound absorbing device comprising a plurality of sound absorbers.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Cavity-type sound absorbers may include perforated structures and may be used in a variety of applications, such as acoustic liners for engines, ventilators for air-conditioning systems, etc.

### SUMMARY

This section generally summarizes the disclosure and is not a comprehensive explanation of its full scope or all its features.

In one embodiment, a sound absorber includes a housing including a back wall, a perimeter wall, and an interior wall that form cells having cavities. The sound absorber also includes a panel disposed on the housing that substantially faces the back wall and encloses the cavities of the cells. The panel defines groups of holes for each cell such that one group of holes extends through the panel to the cavity of one cell and another group of holes extends through the panel to the cavity of another cell.

In another embodiment, a sound absorbing device includes a plurality of sound absorbers arranged in a plane. Each sound absorber includes a housing having a back wall, a perimeter wall, and an interior wall that form cells having cavities. Each sound absorber also includes a panel disposed on the housing that substantially faces the back wall and encloses the cavities of the cells. The panel defines groups of holes for each cell such that one group of holes extends through the panel to the cavity of one cell and another group of holes extends through the panel to the cavity of another cell.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1A illustrates a housing for a sound absorber, the housing including a back wall, a perimeter wall, and an interior wall that form cells having cavities.

FIG. 1B illustrates the sound absorber of FIG. 1A including a panel disposed on the housing that substantially faces the back wall and encloses the cavities of the cells, the panel defining groups of holes for each cell, and the sound absorber having cavities of equal volumes and groups of holes of unequal size.

FIG. 2 illustrates an example of an absorption and reflection spectra of the sound absorbing device of FIG. 1B.

FIG. 3A illustrates a sound absorber having cavities of unequal volumes and groups of holes of unequal size.

FIG. 3B illustrates a sound absorber having cavities of unequal volumes and groups of holes of substantially equal size.

FIG. 3C illustrates a sound absorber having cavities of substantially equal volumes and groups of holes of substantially equal size.

FIG. 4 illustrates a sound absorber having cavities of different depths.

FIG. 5 illustrates a sound absorbing device including a plurality of sound absorbers.

### DETAILED DESCRIPTION

Described herein is a sound absorber and a sound absorbing device including a plurality of sound absorbers. The sound absorber includes a housing including a back wall, a perimeter wall, and an interior wall that form cells having cavities. The sound absorber also includes a panel disposed on the housing that substantially faces the back wall and encloses the cavities of the cells. The panel defines groups of holes for each cell such that one group of holes extends through the panel to the cavity of one cell and another group of holes extends through the panel to the cavity of another cell. The sound absorbing device includes a plurality of sound absorbers arranged in a plane. Both the sound absorber and the sound absorbing device are configured to absorb sound traveling substantially perpendicular to a plane defined by a face of the panel.

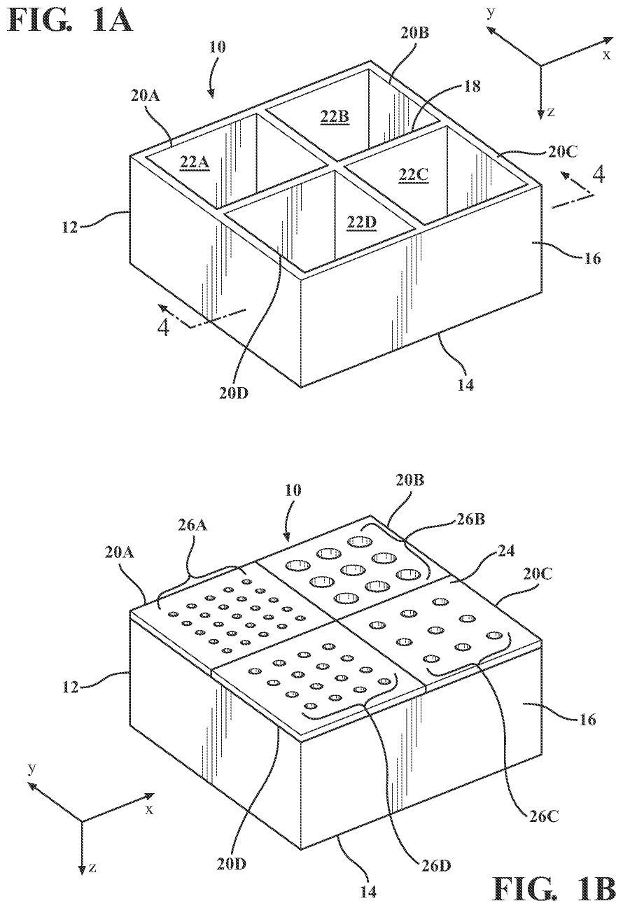

Referring to FIG. 1A, the sound absorber 10 includes a housing 12. The housing 12 includes a back wall 14, a perimeter wall 16, and an interior wall 18. The back wall 14, the perimeter wall 16, and the interior wall 18 form cells 20A, 20B, 20C, and 20D having cavities 22A, 22B, 22C, and 22D. The perimeter wall 16 can be substantially perpendicular to the back wall 14 and substantially parallel to the interior wall 18. However, the sound absorber 10 can have any suitable shape and the perimeter wall 16 does not need to be substantially parallel to the interior wall 18 or substantially perpendicular to the back wall 14. As shown, the back wall 14, the perimeter wall 16, and the interior wall 18 can be configured to form four cells 20A-20D having four cavities 22A-22D. More specifically, cell 20A has cavity 22A, cell 20B has cavity 22B, cell 20C has cavity 22C, and cell 20D has cavity 22D. The cavities 22A-22D may have substantially equal volumes.

Referring to FIG. 1B, the sound absorber 10 also includes a panel 24. The panel 24 can be disposed on the housing 12 such that it substantially faces the back wall 14 (e.g., is substantially parallel to the back wall 14). As such, the panel 24 is configured to enclose the cavities 22 of the cells 20. The panel 24 also defines groups of holes 26A, 26B, 26C, and 26D. For example, as shown, the panel 24 can define four groups of holes 26A-26D. Each of the groups of holes 26A-26D can correspond to each of the cells 20A-20D and each of the cavities 22A-22D such that one group of holes extends through the panel 24 to the cavity of one cell, and another group of holes extends through the panel 24 to the cavity of another cell. For example, group of holes 26A can extend through the panel 24 to the cavity 22A of cell 20A, group of holes 26B can extend through the panel 24 to the cavity 22B of cell 20B, group of holes 26C can extend through the panel 24 to the cavity 22C of cell 20C, and group of holes 26D can extend through the panel 24 to the cavity 22D of cell 20D.

For purposes of clarity, the group of holes 26A includes twenty-five holes arranged in a 5×5 pattern, the group of holes 26B includes nine holes arranged in a 3×3 pattern, the group of holes 26C includes nine holes arranged in a 3×3 pattern, and the group of holes 26D includes sixteen holes arranged in a 4×4 pattern. While each of the patterns shown in FIG. 1B have the same number of holes in each direction (i.e., 3×3, 5×5, etc.), it should be understood that the patterns can vary significantly, such as 3×5, 7×30, 2×6, etc.

In one or more arrangements, as shown in FIGS. 1A and 1B and as described above, the back wall 14, the perimeter wall 16, and the interior wall 18 can form four cells 20A-20D having four cavities 22A-22D within the housing 12. In one or more other arrangements, the back wall 14, the perimeter wall 16, and the interior wall 18 can form any suitable number of cells and cavities. For example, the back wall 14, the perimeter wall 16, and the interior wall 18 can form six cells having six cavities, eight cells having eight cavities, or any other number of cells and cavities. Similarly, in one or more arrangements, as shown in FIG. 1B and as described above, the panel 24 can define four groups of holes 26A-26D. In one or more other arrangements, the panel 24 can define any suitable number of groups of holes. For example, the panel 24 can define six groups of holes, eight groups of holes, or any other number of groups of holes. In these and other arrangements, the number of groups of holes may equal the number of cells, and therefore, the number of cavities.

With continued reference to FIGS. 1A and 1B, the back wall 14, the perimeter wall 16, and the interior wall 18 can form cells having cavities of substantially equal volumes. The panel 24 can define groups of holes having unequal sizes. The size of the holes may be determined by cross-sectional area. More specifically, the holes of one group of holes can have a different size than the holes of another group of holes. For example, group of holes 26A can includes holes having a different size than the holes of groups of holes 26B, 26C, and/or 26D. Group of holes 26B can include holes having a different size than the holes of groups of holes 26C and/or 26D. Finally, group of holes 26C can include holes having a different size than the holes of group of holes 26D. In this example, the group of holes 26B are the largest, the group of holes 26C are the second largest, the group of holes 26D are the third-largest, and the group of holes 26A are the smallest.

The components of the sound absorber 10, such as the back wall 14, the perimeter wall 16, the interior wall 18, and/or the panel 24 may be made of any suitable material. In one example, the material utilized to make one or more of the components of the sound absorber 10 is an acoustically hard material, such as metal, plastics, ceramics, and the like. Additionally, it should be understood that the components of the sound absorber 10 may be separate components or may be unitary structures. For example, the back wall 14, the perimeter wall 16, the interior wall 18, and the panel 24 may be a single unitary structure.

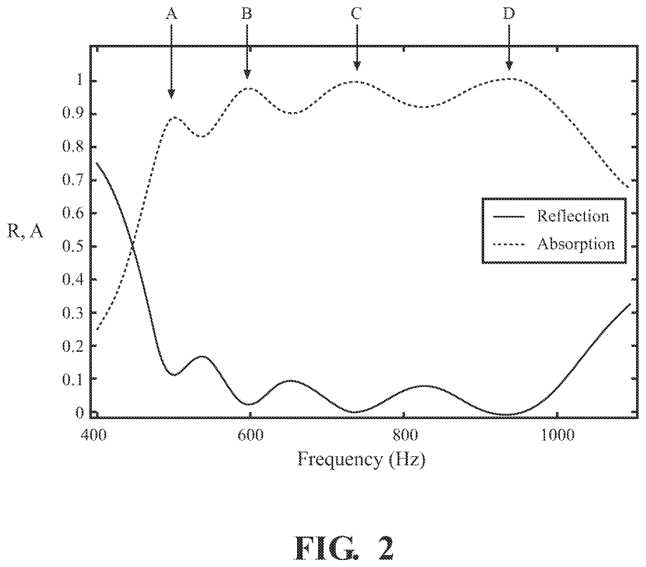

Referring now to FIG. 2, an example of an absorption and reflection spectra of the sound absorber 10 of FIG. 1B is shown. The simulated performance is based on four resonances A, B, C, and D. As indicated in FIG. 2, the sound absorber 10 of FIG. 1B exhibits high absorption (>80%) over a range of frequencies (e.g., 500 Hz-1000 Hz). The absorption may be increased by increasing the number of resonant frequencies of the sound absorber 10. This may be done, for example, by adding cells 20, cavities 22, and groups of holes of various dimensions.

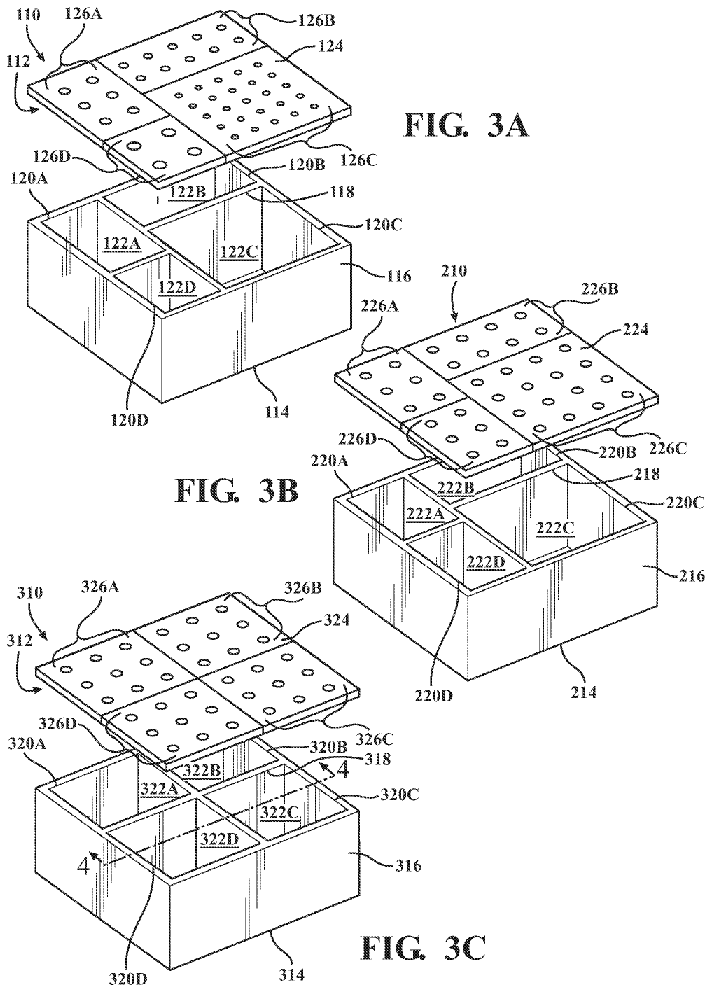

Referring now to FIGS. 3A-3C, variations of the sound absorber 10 of FIGS. 1A and 1B are shown. Like reference numerals have been utilized to refer to like components. As such, any previous description is equally applicable to the examples shown in FIGS. 3A-3C and 5.

As shown in FIG. 3A, a sound absorber 110 includes a housing 112. The housing 112 includes a back wall 114, a perimeter wall 116, and an interior wall 118. The back wall 114, the perimeter wall 116, and the interior wall 118 form cells 120A, 120B, 120C, and 120D having cavities 122A, 122B, 122C, and 122D. The cavities 122A-122D have unequal volumes. More specifically, cavity 122A may have a different volume than cavities 122B, 122C, and/or 122D. Cavity 122B may have a different volume than cavities 122C and/or 122D. Cavity 122C may have a different volume than cavity 122D. The sound absorber 110 also includes a panel 124 defining groups of holes 126A, 126B, 126C, and 126D having unequal sizes.

As shown in FIG. 3B, a sound absorber 210 includes a housing 212. The housing 212 includes a back wall 214, a perimeter wall 216, and an interior wall 218. The back wall 214, the perimeter wall 216, and the interior wall 218 form cells 220A, 220B, 220C, and 220D having cavities 222A, 222B, 222C, and 222D. The sound absorber 210 also includes a panel 224 defining groups of holes 226A, 226B, 226C, and 226D. The groups of holes 226A-226D have holes having substantially equal sizes and the cavities 222A-222D have unequal volumes.

As shown in FIG. 3C, a sound absorber 310 includes a housing 312. The housing 312 includes a back wall 314, a perimeter wall 316, and an interior wall 318. The back wall 314, the perimeter wall 316, and the interior wall 318 form cells 320A, 320B, 320C, and 320D having cavities 322A, 322B, 322C, and 322D. The sound absorber 310 also includes a panel 324 defining groups of holes 326A, 326B, 326C, and 326D. The groups of holes 326A-326D have holes having substantially equal sizes and the cavities 322A-322D have substantially equal volumes.

Referring to FIGS. 1B and 3A-3C, the groups of holes may include any suitable number of holes. In some arrangements, as shown in FIGS. 1B, 3A, and 3B, the groups of holes may include an unequal number of holes. In other arrangements, as shown in FIG. 3C, the groups of holes may include an equal number of holes.

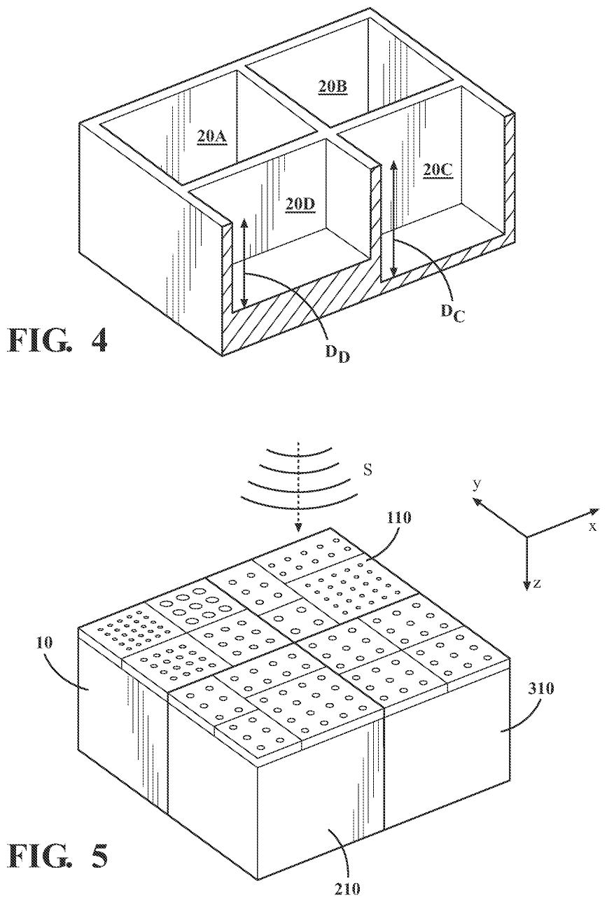

Referring now to FIG. 4, a cross section of the sound absorber 10 of FIG. 1A is shown. In some arrangements, the volume of the cavities 20A-20D may be varied by adjusting the depth of one or more of the cavities 20A-20D. For example, as shown in FIG. 4, cavity 20C may have a depth Dc and cavity 20D may have a depth DD. The depth Dc may be longer than the depth DD. Similarly, the depths of cavities 20A and 20B may be different from each other, the depth Dc, and/or the depth DD.

With reference now to FIG. 5, a sound absorbing device 100 is shown. The sound absorbing device 100 includes a plurality of sound absorbers. The sound absorbers may be arranged in a plane. For example, as shown, the sound absorbers are arranged in the x-y plane. The sound absorbers can be attached to each other as shown, and/or the sound absorbers attached to a separate surface, such as a wall. The sound absorbers can abut each other as shown, or there may be space in between each sound absorber. The sound absorbing device 100 may comprise a wall or a panel that may be used for sound absorbing purposes. Accordingly, the sound absorbing device 100 may be configured to absorb sound waves S traveling substantially perpendicular to a plane defined by the sound absorbing device 100. For example, as shown, the sound absorbing device 100 may be configured to absorb sound waves S traveling along the Z axis towards the panels 24 of the sound absorbers.

As shown in FIG. 5, the sound absorbing device 100 includes each of the types of sound absorbers shown in FIGS. 1A, 1B, and 3A-3C. More specifically, the sound absorbing device 100 includes a first sound absorber 10 having cavities of substantially equal volumes and groups of holes of unequal sizes, a second sound absorber 110 having cavities of unequal volumes and groups of holes of unequal sizes, a third sound absorber 210 having cavities of unequal volumes and groups of holes of substantially equal sizes, and a fourth sound absorber 310 having cavities of substantially equal volumes and groups of holes of substantially equal sizes. By the inclusion of various types of sound absorbers, the sound absorbing device 100 may be configured to absorb sound waves S of varying frequencies. In other words, the sound absorbers of the sound absorbing device 100 may have varying resonant frequencies. In other arrangements, though not shown, the sound absorbing device 100 can include any suitable type of sound absorber.

With reference now to FIGS. 1A, 1B, 3A-5 the sound absorbers of FIGS. 1A, 1B, and 3A-3C and/or the sound absorbing device 110 of FIG. 5 can be formed as separate components attached to each other can be formed integrally as a single component. The sound absorbers of FIGS. 1A, 1B, and 3A-3C and/or the sound absorbing device 110 of FIG. 5 can be formed from any suitable material, for example, plastic, and can be formed in any suitable manner, for example, by 3D-printing.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1A-5, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A sound absorber comprising:
a housing including a back wall, a perimeter wall, and an interior wall that form cells having cavities, the cavities defining different cavity cross-sectional areas; and
a panel disposed on the housing that substantially faces the back wall and encloses the cavities of the cells, the panel including panel sections defining different panel section cross-sectional areas corresponding to the cavity cross-sectional areas, and the panel defining groups of holes for each cell such that one group of holes extend though the panel to the cavity of one cell and another group of holes extend through the panel to the cavity of another cell, wherein a hole size for each group of holes is different for each panel section.

2. The sound absorber of claim 1, wherein:
the interior wall at least partially defines four cells within the housing;
the panel defines four panel sections corresponding to the four cells; and
the panel defines four groups of holes.

3. The sound absorber of claim 1, wherein the cavities of the cells have substantially equal volumes.

4. The sound absorber of claim 1, wherein the cavities of the cells have unequal volumes.

5. The sound absorber of claim 1, wherein each of the groups of holes include an equal number of holes.

6. The sound absorber of claim 1, wherein each of the groups of holes include an unequal number of holes.

7. (canceled)

8. (canceled)

9. The sound absorber of claim 1, wherein the sound absorber is configured to absorb sound waves traveling substantially perpendicular to a plane defined by a face of the panel.

10. The sound absorber of claim 1, wherein the sound absorber is configured to absorb sound having a frequency range of substantially 500 Hz to substantially 1000 Hz.

11. A sound absorbing device, comprising:
a plurality of sound absorbers arranged in a plane, each sound absorber comprising:
a housing including a back wall, a perimeter wall, and an interior wall that form cells having cavities, the cavities defining different cavity cross-sectional areas; and
a panel disposed on the housing that substantially faces the back wall and encloses the cavities of the cells, the panel including panel sections defining different panel section cross-sectional areas corresponding to the cavity cross-sectional areas, and the panel defining groups of holes for each cell such that one group of holes extend though the panel to the cavity of one cell and another group of holes extend through the panel to the cavity of another cell, wherein a hole size for each group of holes is different for each panel section.

12. The sound absorbing device of claim 11, wherein:
the interior wall at least partially defines four cells within the housing;
the panel defines four panel sections corresponding to the four cells; and
the panel defines four groups of holes.

13. The sound absorbing device of claim 11, wherein the cavities of the cells have substantially equal volumes.

14. The sound absorbing device of claim 11, wherein the cavities of the cells have unequal volumes.

15. The sound absorbing device of claim 11, wherein each of the groups of holes include an equal number of holes.

16. The sound absorbing device of claim 11, wherein each of the groups of holes include an unequal number of holes.

17. (canceled)

18. (canceled)

19. The sound absorbing device of claim 11, wherein the plurality of sound absorbers are configured to absorb sound waves traveling substantially perpendicular to a plane defined by the sound absorbing device.

20. The sound absorbing device of claim 11, wherein each of the plurality of sound absorbers have different resonant frequencies.
